(19) United States
(12) Patent Application Publication
(10) Pub. No.: US 2017/0357941 A1
(43) Pub. Date: Dec. 14, 2017

(54) Systems and Methods For Facilitating Paperless Divorce Proceedings

(71) Applicant: Redline Ready LLC, Scottsdale, AZ (US)

(72) Inventors: Lee Best, Scottsdale, AZ (US); Cindy Best, Scottsdale, AZ (US)

(21) Appl. No.: 15/182,402

(22) Filed: Jun. 14, 2016

(51) Int. Cl. G06Q 10/10; G06F 17/24; G06Q 20/10; G06Q 50/26; G06Q 50/18

(52) U.S. Cl. CPC G06Q 10/10; G06F 17/243; G06Q 20/102; G06Q 50/18; G06Q 50/26

(57) ABSTRACT

Methods and systems for filing a divorce using an on line portal having an associated database without revealing the forms filed with the court to the user. The method includes interrogating the database to identify required forms; eliciting predetermined information from the user; populating the forms using the elicited information; and filing the populated forms in court; wherein the forms are not displayed to the user.

### TECHNICAL FIELD

The present invention relates, generally, to systems and methods for facilitating the divorce process and, more particularly, to an on-line web-based portal for filing divorce documents without the user having to view the documents.

### BACKGROUND

Large numbers of divorce cases are routinely filed in every county in the United States on a daily basis. In addition to the staggering financial toll, both parties suffer emotionally. Not surprisingly, many people have a strong distaste for the legal complexities associated with divorce, including the costs, fees, attorneys, opposing parties, and the numerous forms and documents the process requires.

Presently known techniques for automating the forms process typically prompt the user to answer question on-line, and use the answers to populate the forms. When all of the forms are filled out, the user is prompted to print, sign, and file the forms with the court. This process is tedious, cumbersome, and emotionally draining.

For example, the Superior Court website for Maricopa County, Arizona asks the user questions, and fills out the appropriate forms for the user, then prompts the user to print, sign, and file. (See, www.superiorcourtmaricopa.gov/SuperiorCourt/FamilyCourt/). Moreover, while the initial Petition is typically filed manually, courts are increasingly adopting e-filing protocols for electronically filing most other documents and forms with the court.

Legalzoom™ provides state-specific divorce documents for both spouses, including a summons, petition or complaint, marital settlement agreement, parenting plan, decree and other state-required documents, as well as instructions for the user to file the documents with the court. (See, https://www.legalzoom.com/personal/marriage-and-divorce/divorce-overview.html). Other on-line divorce document preparations services include completecase.com, 3stepdivorce.com, mydivorcepapers.com, rocketlawyer.com, and phoenixdocprep.com. In addition, hard copy divorce guides include “The Divorce Coach” by Cynthia Best and Tali Collins (ISBN: 1507873883). The entire contents of the foregoing are hereby incorporated by this reference.

While presently know divorce assistance techniques help users fill out forms, the user is nonetheless required to manually finalize the actual forms, print them, or otherwise attend to filing them with the court. Systems and methods are thus needed which overcome the limitations of the prior art. Specifically, systems and methods are needed which guide the user through the process of filing a divorce, without the user having to see the actual forms filed with the court.

Various features and characteristics will also become apparent from the subsequent detailed description and the appended claims, taken in conjunction with the accompanying drawings and this background section.

### BRIEF SUMMARY

Various embodiments of the present invention relate to systems and methods for, inter alia: i) filing a divorce via an on line portal whereby the system prepares and files the documents without the user viewing them; ii) maintaining a relational database of the substantive and procedural requirements for prosecuting a divorce in a number of jurisdictions; iii) facilitating on line notarization and/or verification of pleadings in real time or near real time; and iv) using biometric indicia for verifying the user's identity.

A client facing document preparation service allows a user to file a divorce proceeding without the need for an attorney, using real time or near real time form population, while concealing the forms from the user to reduce stress and perceived complexity. We elicit [name] once, and populate to multiple forms. In this way, a lawyer-less and/or form-less divorce (or other legal transaction) proceeding is facilitated.

It should be noted that the various inventions described herein, while illustrated in the context of a divorce, are not so limited. Those skilled in the art will appreciate that the systems and methods described herein may contemplate any legal or administrative proceeding.

Various other embodiments, aspects, and features are described in greater detail below.

### BRIEF DESCRIPTION OF THE DRAWING FIGURES

Exemplary embodiments will hereinafter be described in conjunction with the following drawing figures, wherein like numerals denote like elements, and:

FIG. 1 is a flow chart illustrating a three step process for filing a divorce proceeding in which the system files verified documents in the court without the user having to see them, in accordance with various embodiments;

FIG. 2 is a schematic block diagram illustrating how information pertaining to jurisdiction, eligibility, and the requested task is used to trigger payment in accordance with various embodiments;

FIGS. 3A-3B is a schematic block and flow diagram illustrating user qualification and purchase options in accordance with various embodiments;

FIGS. 4A-4B is a schematic block and flow diagram illustrating payment and registration in accordance with various embodiments;

FIGS. 5A-5B is a schematic block and flow diagram illustrating the preparation and/or filing of initial documents in accordance with various embodiments;

FIGS. 6A-6B is a schematic block and flow diagram illustrating case management in accordance with various embodiments;

FIG. 7 is a schematic block and flow diagram illustrating a countdown timer module in accordance with various embodiments;

FIG. 8 is a schematic block and flow diagram illustrating a case progress tracker module in accordance with various embodiments;

FIG. 9 is a schematic block and flow diagram illustrating a matter information module in accordance with various embodiments; and

FIG. 10 is a flow chart illustrating a process implemented by an on-line portal for facilitating the preparation, filing, and service of a divorce case in a manner which avoids the user having to view documents filed with the court and served on the opposing party in accordance with various embodiments.

### DETAILED DESCRIPTION

The following detailed description of the invention is merely exemplary in nature and is not intended to limit the invention or the application and uses of the invention. Furthermore, there is no intention to be bound by any theory presented in the preceding background or the following detailed description.

Various embodiments of the present invention relate to systems and methods for assisting an individual who needs a divorce now, but does not want to deal with a lawyer or view the documents which must be filed with the court. One objective is to quickly and efficiently advance the interactive process until the user can press “file” and be done with the process, even though additional steps may need to be taken by the system which are transparent to the user.

For jurisdictions that allow electronic filing (or e-filing), the system files the documents in real time without the user having to go to court. For jurisdictions that do not allow electronic filing, the system attends to filing the documents as soon as practicable, for example by batch filing on the next business day, in which case the system may be configured to inform the user that a notice (e.g., text message, email) will subsequently be sent confirming filing.

In an embodiment, the system may employ a data structure containing various substantive, procedural, formal, jurisdictional, filing, and/or other requirements for a plurality of courts and/or counties, and automatically determines such requirements in real time or near real time. The system may access the foregoing database and process a plurality of if/then/else instructions for preparing the documents and following through with filing.

In an embodiment, the system evaluates three essential metrics before requesting payment, namely: i) jurisdiction; ii) eligibility/qualification; and iii) purchase options (i.e., what task and, hence, what forms are needed). Once payment is secured, the system elicits the information needed to populate the required forms, and arranges for filing and service, as appropriate.

With regard to jurisdiction, the system requests the information necessary to determine the appropriate jurisdiction in which the action has already been filed or will be filed. With regard to eligibility/qualification, the system may ask the questions required in that jurisdiction, such as: i) Is the marriage irretrievably broken? ii) Has either spouse lived in the jurisdiction for the last 90 days (or other statutorily required period)?

With regard to purchase options, the system may determine if a divorce proceeding is currently pending, for example, by asking if the user's spouse has already filed a divorce petition. If so, the system may determine that the user needs to purchase the task of responding to the petition (also referred to as filing an answer). Stated another way, the purchase options query resolves to a definitive set of forms, for which the system then elicits or otherwise determines the information needed to populate the required forms. Significantly, only the essential metrics necessary to determine a payment amount are evaluated prior to requesting payment; the remaining information needed to complete the requested task(s) is elicited after payment has been secured.

For those tasks for which papers must be served on the opposing party (e.g., a summons and/or an original petition for divorce), the system may be configured to either allow the user to serve the documents or, alternatively, the system may arrange service. For example, the system may automatically generate documents necessary to: i) effect certified mailing; ii) seek publication in a local newspaper; iii) obtain a written waiver or acceptance of service from the opposing party; and/or iv) make arrangements with a process server to personally serve the documents. In this regard, it is noted that some jurisdictions may allow the green “acceptance” cards associated with certified mail to be e-filed.

In one embodiment, the system may be configured to allow a party (or party representative) to “click here” to accept service, whereby the user is presented with a, signature box, a protocol available from a document signing service (e.g. www.docusign.com) or other verification, whereupon the acceptance of service, consent decree, or other evidence of acceptance and/or verification is prepared and/or filed on behalf of the user.

In an embodiment, the system may perform a real time check to determine whether the user's spouse has already filed in any jurisdiction accessible by the system.

In one particularly preferred embodiment, referred to herein as an uncontested use case, the system prepares and process documents corresponding to: 1) the petition; 2) consent to service; and 3) consent decree in real time or near real time (near real time generally corresponds to the next business day or the next day in which batch processing or delivery is effected). In an alternative use case, the documents include the petition service of process.

In a further alternative use case, the documents take the process of preparing the divorce papers as far as possible when the court is either not in session or the system is otherwise unable to file the documents in real time. In this case, the system may display a message to the user such as: “You have done all you need to do for now—your case will be filed for you by noon tomorrow.” If notarization is required, the system may be configured to invoke a real time on-line notary module or equivalent (e.g., take a photograph of the user, scan the user's driver's license or other documentation, obtain a fingerprint, retinal scan, or other biometric indicia).

Presently known techniques for on line notarization, or otherwise verifying a user's signature and/or identity on line include www.notarieslive.com, www.notarylive.net, www.readnotify.com/readnotify/notary.asp, https://www.notarycam.com, and https://wwv.signix.com/secure-electronic-notarization.

Those skilled in the art will appreciate that each individual jurisdiction may define which documents require verification, notarization, and the like, and that these requirements may change over time. For example, the initial petition and the acceptance of service typically require verification. Accordingly, a preferred embodiment contemplates a database of the requirements for a plurality of jurisdictions, updated using a real time or near real time feed (e.g., an RSS (really simple syndication) feed).

In accordance with an embodiment, it may be desirable to allow a user to verify the information in a document, without actually having to review the document into which the verified information is merged. This technique is referred to herein as a “formless forms process.” In this way, the user can accomplish a desired task without having to review or even see the documents filed with the court, so long as the information contained in the document is properly verified.

In addition, a real time or near real time verification technique may be employed in the context of acceptance of service. In this way, the system can notify the opposing party that documents are forthcoming, and request that the opposing party cooperate by using the foregoing non-traditional acceptance modalities.

In an uncontested divorce proceeding, acceptance of service can be e-filed, either separately or as part of a consent decree. In an embodiment, the system may invite the respondent to a shared portal to either settle or litigate contested issues. In an embodiment, the parties may agree to skip the response and go straight to consent decree.

In accordance with a further embodiment, if the case can be e-filed in real time, the court returns a case number which the system assigns to the case. Alternatively, the system may obtain a block of sequential case numbers from the court in advance pursuant to a pre-existing agreement, and assign sequential case numbers and report the corresponding information back to the court. In yet a further alternative embodiment, the system may be configured to interleave case numbers into the court's docketing system in parallel with case numbers assigned by the court.

In an embodiment, a consent decree can be automatically generated by both parties, or by one party who then asks the other to agree with what has been proposed. This can include property division, spousal maintenance, parental visitation, parental rights, for which drop down check lists may be provided.

However, in some jurisdictions, a consent decree may not be filed for at 60 days (or other statutory period) following service of the initial complaint or petition. In this case, if both parties agree and sign the consent decree in advance, the system may be configured to we hold the consent decree for 60 days, and issue a notice to the user which states that: “your consent decree will be held and filed 60 days after service unless you or your spouse inform us otherwise.” Consent decrees can typically be e-filed.

Once the judge signs the consent decree, the court typically mails copies to the parties using traditional surface mail. In an embodiment, the system may be configured to periodically ping the court database to determine when a consent decree or other judicial document has been signed and/or issued by the court (or dispatch a person to the court to retrieve the document), and provide an electronic copy to one or both parties before the mailed copy arrives.

In circumstances where only the party (or the party's attorney) is authorized to review the case on line, the system may be configured to prompt the user to create an the account, save the login/password information to the portal, and authorize the system to use the saved credentials to check the case file for court documents, even if an attorney has not appeared on behalf of the user. In effect, the user can authorize the system to manage the user's electronic court records (ECR) account as an extension of the user.

In an embodiment, a graphical case tracker interface may be updated in real time or near real time as each step of the process is completed. However, the system may also be configured to allow the user to take affirmative steps to expedite certain steps in the process, for example if the user chooses not to wait for service of process via certified mail, and elects to intervene by attempting personal service. The process server can then e-file the affidavit of service, which updates the case tracker graphical interface to reflect that the next step in the process has been satisfied.

In an embodiment, the system may be configured to prepare an appropriate response to a petition that user has not seen, for example by scanning the petition using key word searches and/or natural language techniques and asking questions such as: do you live where alleged; are the allegations regarding children correct; do you agree with the proposed spousal maintenance, and the like. Alternatively, the user can be prompted to check boxes or otherwise address all issues which could properly have been raised in the petition, even without actually reviewing the petition (or other document the user is responding to.

To further facilitate a formless forms approach, the system may be configured to we ask questions or otherwise elicit information from the user, and use the information to populate and file forms with the court or other administrative or government agency. In various embodiment, the user has the option to see the filed forms if desired, but need not ever see them if the user chooses not to.

In accordance with an embodiment, a system and method are provided for: i) determining a particular divorce-related task to be performed (e.g., prepare and file a petition); ii) identifying the appropriate court and the forms required by that court to implement the desired task; iii) eliciting information from the user and populating the required forms; and iv) filing the forms in the court; wherein some or all of the forms are never shown to the user.

In an embodiment, the system may be configured to collect the filing fee from the user and pay the filing fee to the court on the user's behalf, instruct the user to pay the filing fee directly to the court, or provide a window to the court's website to facilitate payment of the filing fee by the user.

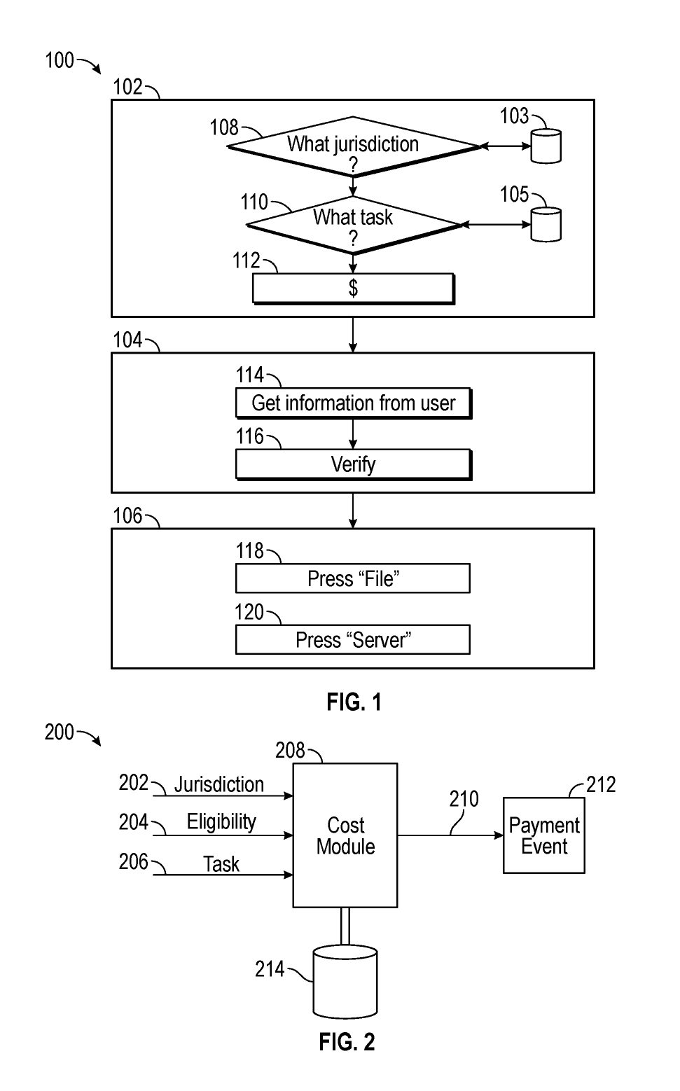

Referring now to FIG. 1, a three step process 100 for filing a divorce case on line without the user having to see the documents filed with the court is shown. The process 100 includes determining the documents required to perform a desired task (Step 102), completing the forms (Step 104), and filing the forms to thereby complete the task (Step 106).

With continued reference to FIG. 1, Step 102 may comprise determining the appropriate jurisdiction in which the case should be filed (Step 108). In an embodiment, this may be accomplished by automatically determining the geolocation of the device employed by the user (e.g., laptop or mobile computing device), prompting the user to identify a location (e.g., city, county) via a drop down menu, scamming a driver's license, or otherwise eliciting address information and determining the appropriate jurisdiction from the corresponding zip code, for example by interrogating a database 103 which maps user addresses to judicial districts.

Step 102 may also comprise determining what task the user desires to perform, and determining which documents are required to be filed in order to perform that task (Step no). In an embodiment, this may be accomplished by interrogating a database 105 which includes the forms, filing fees, and/or other filing requirements and protocols associated with performing various tasks in a plurality of jurisdictions. In the illustrated embodiment, Step 102 further comprises determining the cost and/or fees associated with performing the desired task in the selected jurisdiction (Step 112). Once the costs and fees are determined, a request for payment may be presented to the user.

With continued reference to FIG. 1, Step 104 may comprise acquiring (step 114) from the user any additional information needed to populate the forms identified in Step 102. This may be done using any combination of drop down menus, natural language techniques, heuristic engines, open ended questions, or translating the information fields identified in the forms into closed ended questions presented to the user. This information is then used to populate the required forms. Significantly, this may be accomplished using a formless forms approach, whereby the forms to be filed with the court are not shown to the user, although this may be done if requested by the user.

As discussed above, certain documents require notarization, verification, or other attestation by the user. In order to avoid showing the document to the user while still complying with the requirements of the court, the system may be configured to ask the user to notarize, verify, or otherwise attest to the accuracy, truthfulness, or veracity of the underlying information used to populate the form, rather than the form itself. While this may seem to be an exercise in semantics, it is an important distinction to an emotionally distraught user who simply wants to file for divorce, but who does not understand the complexity of standard court forms.

Accordingly, Step 104 includes a verification step 116, which may be accomplished in any manner acceptable to the court, as may be revised from time to time.

Step 106 may comprise a “one click” filing protocol, whereby the user is prompted to press a virtual button or otherwise instruct the system to file the documents needed to perform the desired task (step 118). Upon filing the documents in the appropriate court, the system may prompt the user to commence service (step 120), if appropriate. Once the documents are filed and service commenced (if needed), a reassuring message may be provided to the user, such as: “Relax. You have now done all you need to do at this time to file your divorce.” As discussed above, once the opposing party is actually served, the system may be configured to send a follow up message to the user, such as: “Your spouse has been served. The injunction is now in effect.”

FIG. 2 graphically illustrates a technique 200 for determining the appropriate point in the process of filing a divorce at which a user is presented with a payment request. In the illustrated embodiment, a cost module 208 outputs a payment request 210, which is displayed at a user computing device 212, wherein the payment request is responsive to at least the following inputs from the user: jurisdiction 202; eligibility 204; and objectives 206. As discussed above, the jurisdiction metric 202 relates to the particular court having jurisdiction over the requested task. The eligibility metric 204 relates to whether this particular user is eligible to request the desired task. For example, if the user seeks to file for divorce in a particular jurisdiction, the system may ask a series of questions to determine if the user is eligible to file for divorce based on the eligibility requirements for that jurisdiction. The objectives metric 206 relates to the task the user desires to have the system perform, such as: file a divorce petition; file a response to a petition previously filed by the user's spouse; file a consent decree; or any other task associated with a divorce or other civil or criminal proceeding.

In the illustrated embodiment, the cost module 208 may be configured to access a database 214 which may include, inter alia, the forms needed to complete the desired task, the court costs and fees for filing the completed task, a service fee charged by the system for completing the task, and various third party costs and fees associated with verifying the user's identity (e.g., on line notarization), electronic signature capture, serving the filed documents upon an opposing party, and the like.

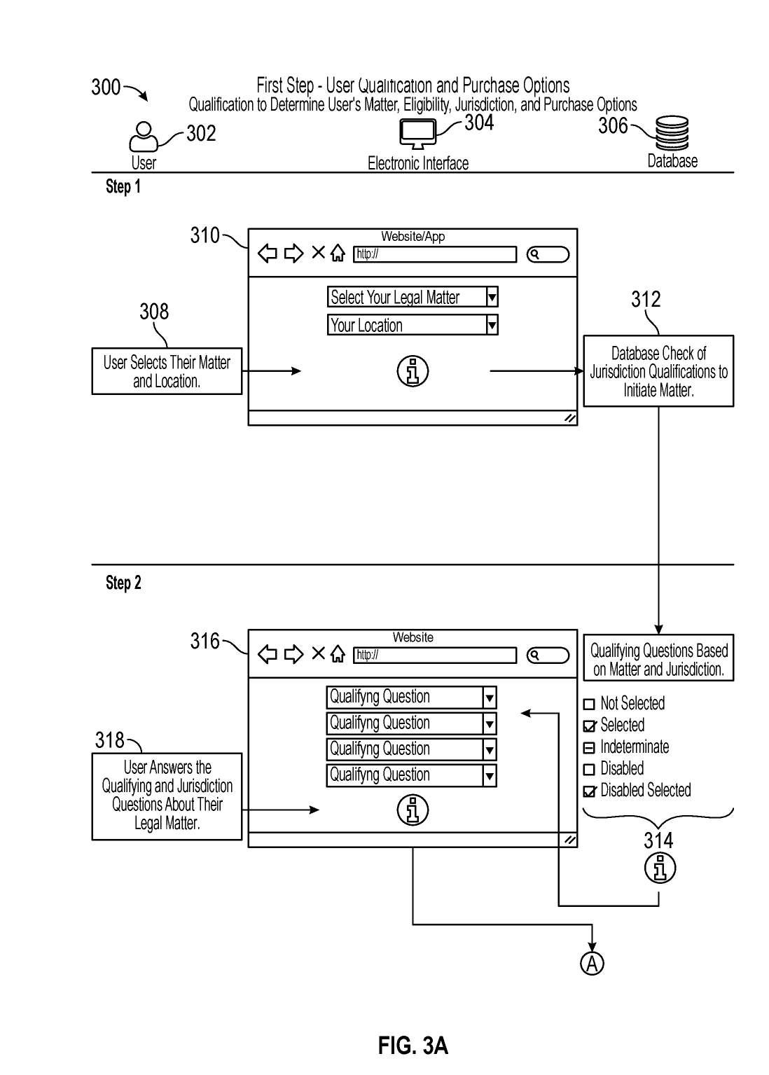

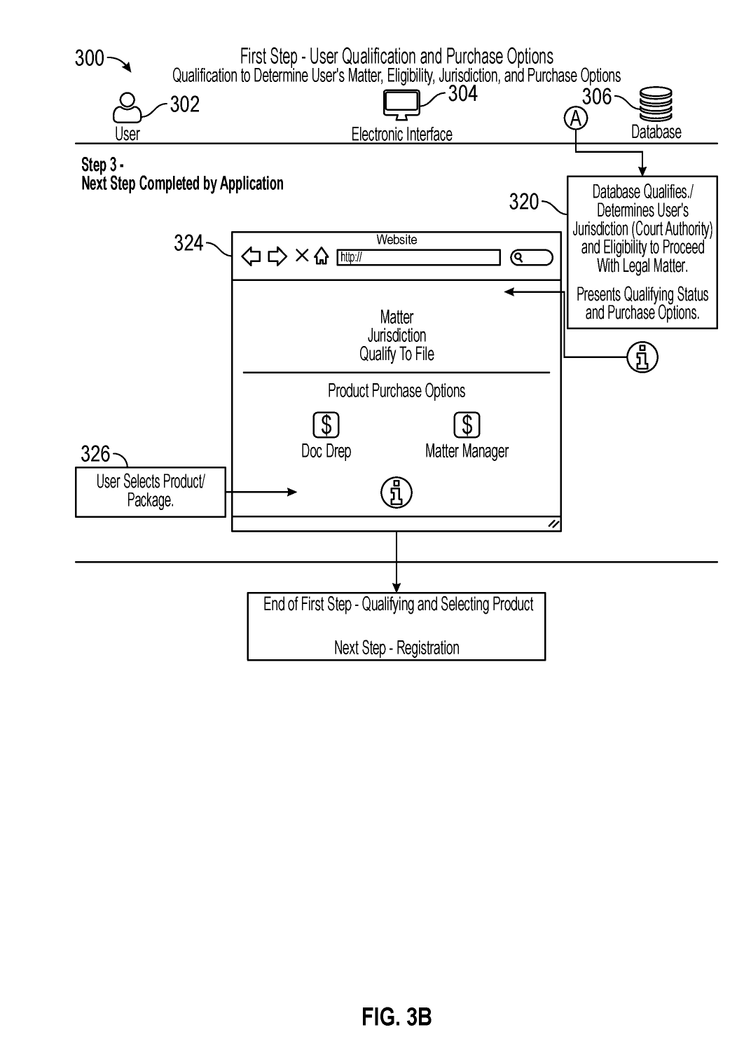

FIG. 3 is a flow diagram 300 depicting the interaction among a user 302, an electronic interface 304 associated with an on line portal, and one or more databases 306 which cooperate to determine the jurisdictional, user eligibility, and purchase options discussed above in connection with FIG. 2. More particularly, the flow diagram 300 includes the user selecting a desired task and indicating a location (item 308), for example using drop down menus as shown in the exemplary screen shot 310. The system platform then interrogates the database 306 to determine the eligibility requirements in the selected jurisdiction (item 312). Qualifying questions based on the task to be performed and the jurisdiction are retrieved from the database (item 314) and displayed on the user interface (item 316), whereupon the user answers the questions (item 318).

Based on the user's answers in item 318, the system determines if the user meets the eligibility requirements for the desired task in the selected jurisdiction (item 320). If the user qualifies, the system may present purchase options (item 324), including price and payment details. In a preferred embodiment, the user may purchase a document preparation product which includes populating the documents needed to complete the selected task in the selected jurisdiction, as well as an optional matter management product for tracking the case as it progresses through the court system. The user then selects the desired products for purchase (item 326).

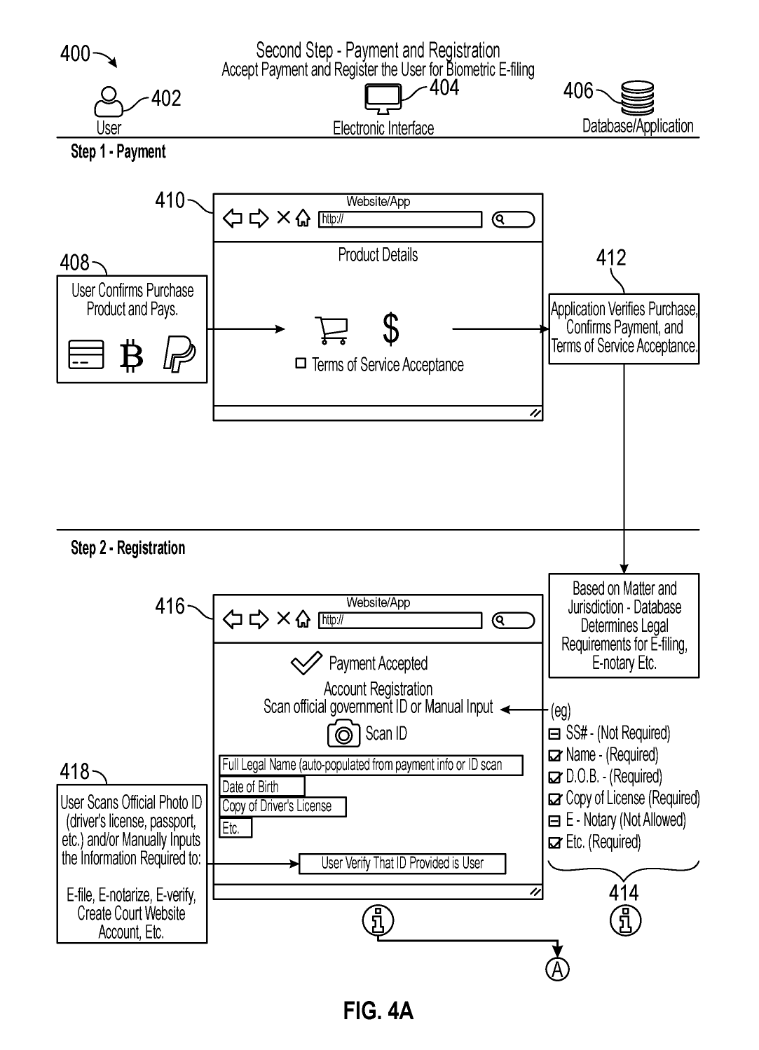

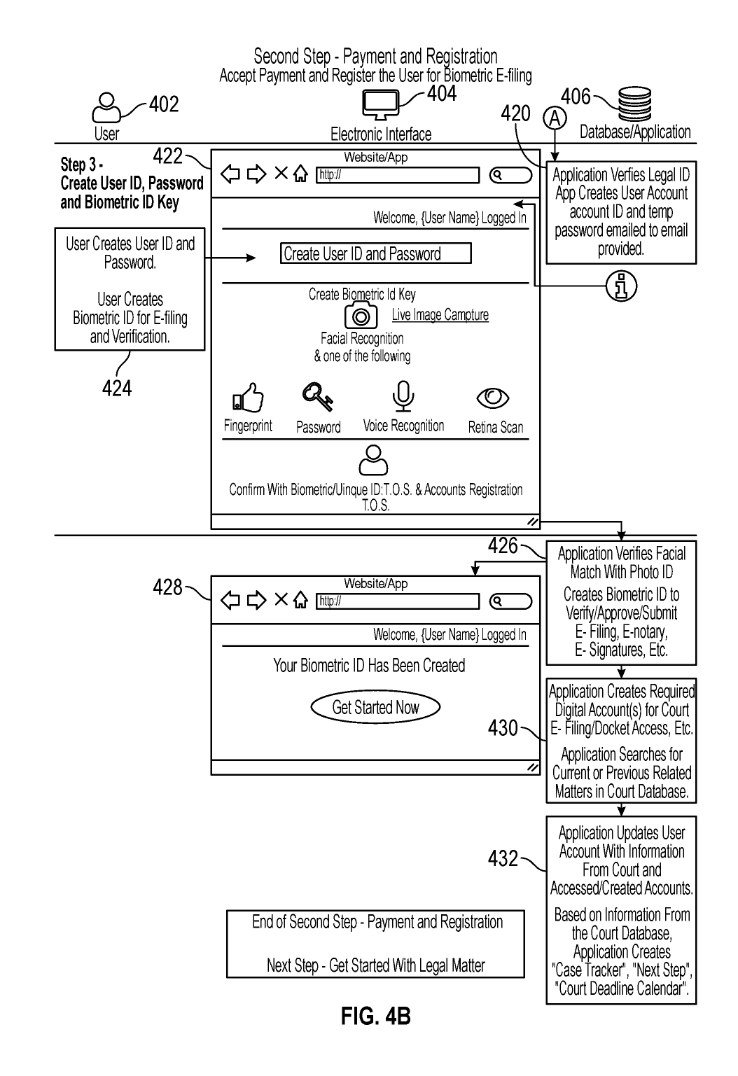

Referring now to FIG. 4, a schematic block and flow diagram 400 illustrating payment and registration among a user 402, an electronic interface 404 associated with an on line portal, and one or more databases 406. In particular, the flow diagram 400 depicts the user confirming the product(s) to be purchased and payment therefor (item 408). The system may then display the product details, instructions, terms of service, and the like (item 410) for the user's review and/or approval. The system may then verify the purchase, confirm payment, and note the user's acceptance of the terms of service (item 412).

The system may then interrogate the database 406 to determine what steps need to be taken to complete the selected task in the selected jurisdiction (item 414), including both the substantive aspects (e.g., identifying which forms need to be filed and the information needed to populate those forms), as well as the procedural aspects (e.g., whether e-filing is permitted, and what type of verification and/or notarization may be required). The system may then interactively prompt the user for the information needed to set up an account and register with the court system in which the task is to be performed (item 416). In most jurisdictions, this information includes full name, date of birth (DOB), and the like. In an embodiment, the user may scan, swipe, or photocopy a driver's license or other government issued identification card (which preferable includes a photo and/or other biometric indicia), and verify that the user is the rightful owner of the scanned ID (item 418).

With continued reference to FIG. 4, the system may be configured to create a user account within the system and to text, email, or otherwise provide a temporary password to the user (item 420). The system may then prompt the user to create a biometric ID key (item 422) for use in verifying the identity of the user. The biometric indicia may include a live image capture of the user's face (photograph and/or video), one or more finger or palm prints, one or more passwords, voice recognition, retinal scan, and the like (item 422). The user may then create and/or confirm the user ID and password, and submit biometric identification information to the system to facilitate subsequent legal verification of pleadings (e.g., notarization, e-notary) (item 424).

The system may be configured to verify the user's identity, for example by comparing the captured facial match (real time photo) against the scanned photo ID (e.g., driver's license) (item 426). The system may also create a biometric identification scheme based on the user submitted biometric information from item 424. If the system confirms that the user is who the user purports to be, the system may create or facilitate the creation of one or more digital accounts with the court for e-filing, docket access, case tracking, payment, on line verification, as appropriate (item 430).

In addition, the system may search the court database for previous, co-pending, or related matters which may potentially impact the task currently being performed. If appropriate, the system may update the user account with any such related information. Based on information retrieved from the court database, the system creates case tracker, next step, and court deadline calendar user tools (item 432).

With continued reference to FIG. 4, the system also creates a protocol for allowing the user to securely access the case file and otherwise perform authenticated functions using the biometric identification scheme via the on line portal (item 428). More particularly, in various embodiments, the user may desire to have the system prepare and file documents without the user having to view the documents. However, some jurisdictions may require certain documents to be notarized or otherwise verified. Accordingly, by prompting the user to verify that the information used to populate the documents is true and correct, the present invention allows the user to verify the information—and thus comply with the court requirements for notarization and/or verification—without requiring the user to actually view the documents as filed with the court.

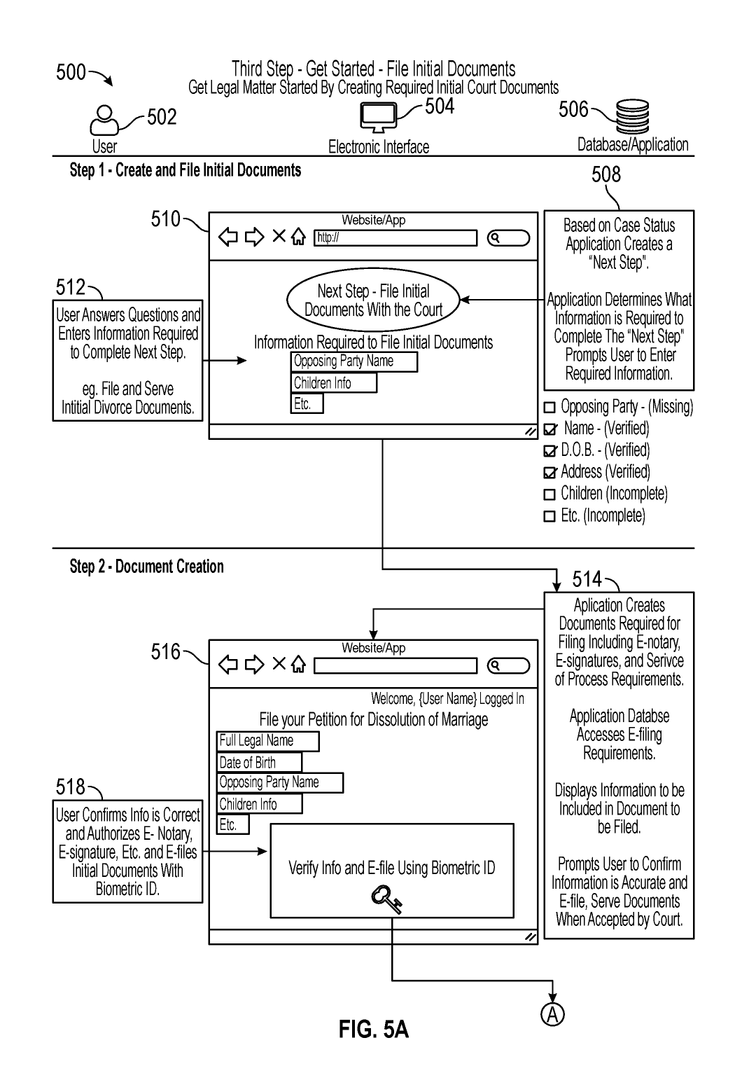

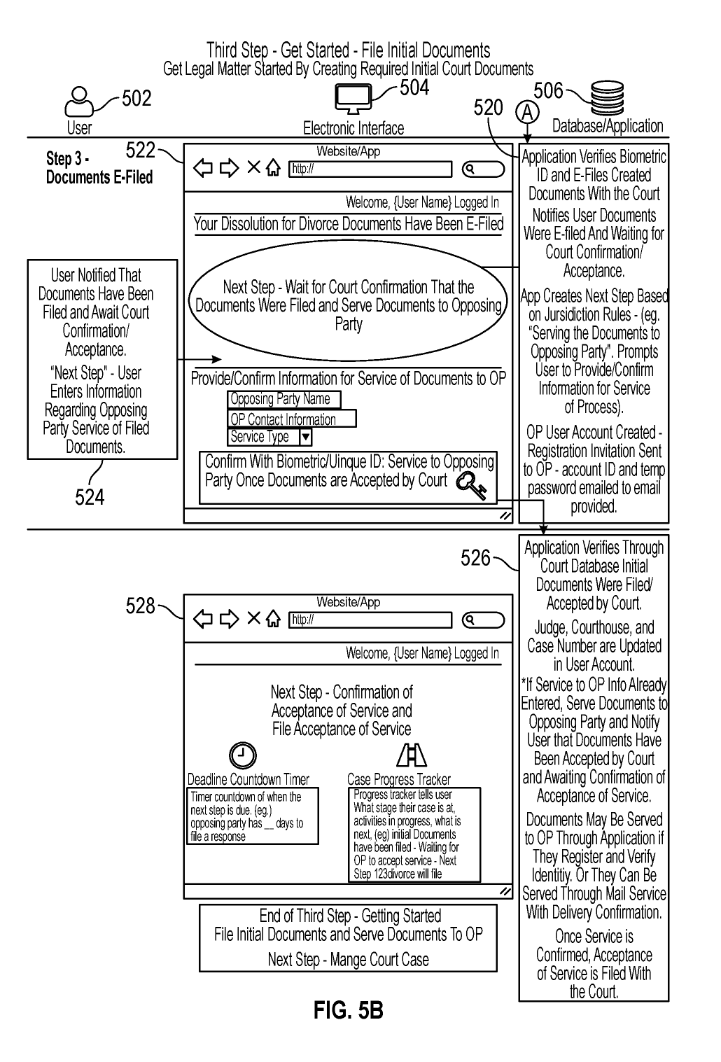

FIG. 5 is a schematic block and flow diagram 500 illustrating the preparation and filing of initial documents by a user 502 using an electronic interface 504 associated with an on line portal while accessing and one or more databases 506. In particular, the flow diagram 500 depicts a “next step” action based on the then current status of the case (item 508). In particular, the system may determine what information is needed from the user in order to populate the forms which must be filed to complete the requested task, and prompts the user to provide the information (item 510). In a typical use case, the requested task involves filing and serving initial documents for an uncontested divorce (e.g., complaint, summons, and consent decree) (item 512). Accordingly, the user may be prompted to enter the opposing party's name, and information regarding minor children, marital assets, and the like (item 510).

The system then uses the information provided by the user to populate the required documents, and prepares the necessary filing papers such as e-filing and e-notary documentation (item 514). In a preferred embodiment, the system interrogates the database to determine which documents need to be filed with the court in connection with the requested task, and uses heuristics and natural language techniques to determine the information needed to populate the forms. The system also retrieves e-filing and verification (e.g., notarization) particulars from the database. In a particularly preferred embodiment, the system displays the information to be included in the documents to be filed, and prompts the user to confirm the accuracy of the information, without the having to review the documents themselves (item 516). The user may then confirm the accuracy and/or truthfulness of the information—without having to review the actual forms being filed—and authorizes e-notary, e-verification, and/or e-signature using the aforementioned biometric identification scheme (item 518).

With continued reference to FIG. 5, the system may be configured to verify the biometric indicia provided by the user, and file the verified documents with the court, either electronically (if permitted) or physically (item 520). The system may then notify the user that the documents were e-filed, and that the system is awaiting confirmation from the court. The system then creates a next step based on rules from the appropriate jurisdiction, such as “serve documents on opposing party,” and prompts the user to confirm the information needed for service of process (e.g., the opposing party's address) (item 520).

The system may be configured to display a confirmation message to the user, such as “Your divorce documents have now been sent to (or filed with) the court” (item 522), whereupon the user may enter and/or confirm the information necessary to effect service of process, including selecting the mode of service (e.g., certified mail, electronic, human process server, and the like) (item 524).

The system may be configured to confirm, for example by interrogating the court database, that the documents were accepted by the court, and to update the user account records to reflect the assigned case number, judge, courthouse, and other information relevant to the case (item 526). The system then takes steps to serve the documents on the opposing party according to the one or more service modalities selected by the user, such as: requesting that the opposing party accept service or waive service; service by mail; the filing of an affidavit of service by a process server; service by publication; or acceptance of service whereby the opposing party verifies service through a biometric authentication scheme as described above. Once service is complete, the system arranges to file appropriate evidence of service with the court (item 526). The system may then display a notice to the user that service has been effected (item 528).

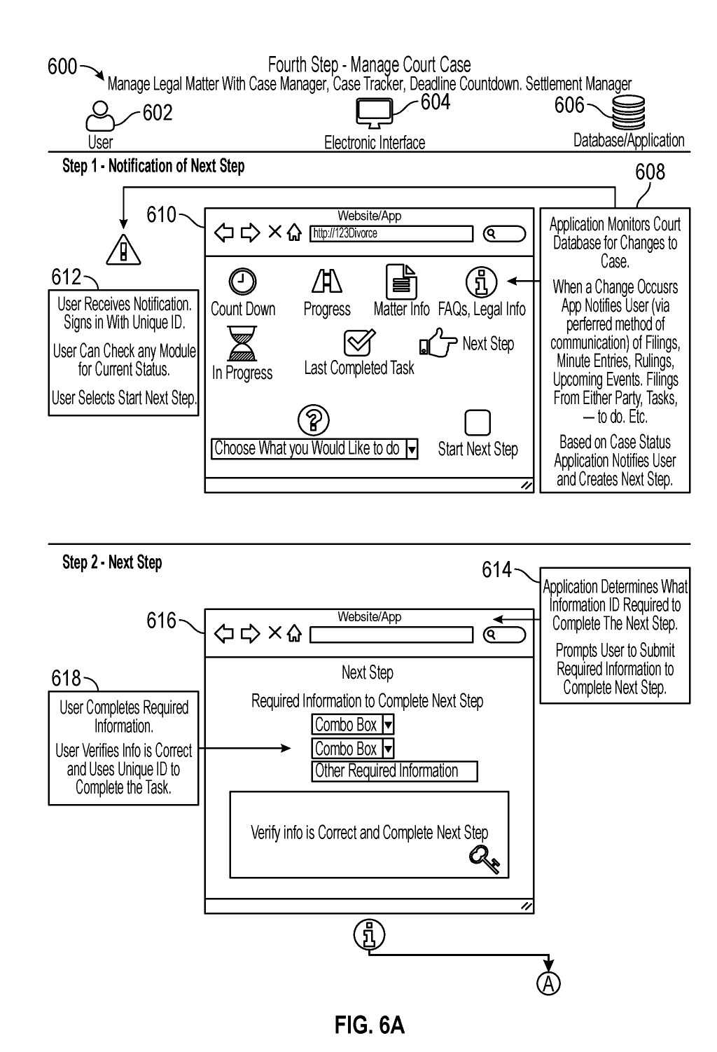

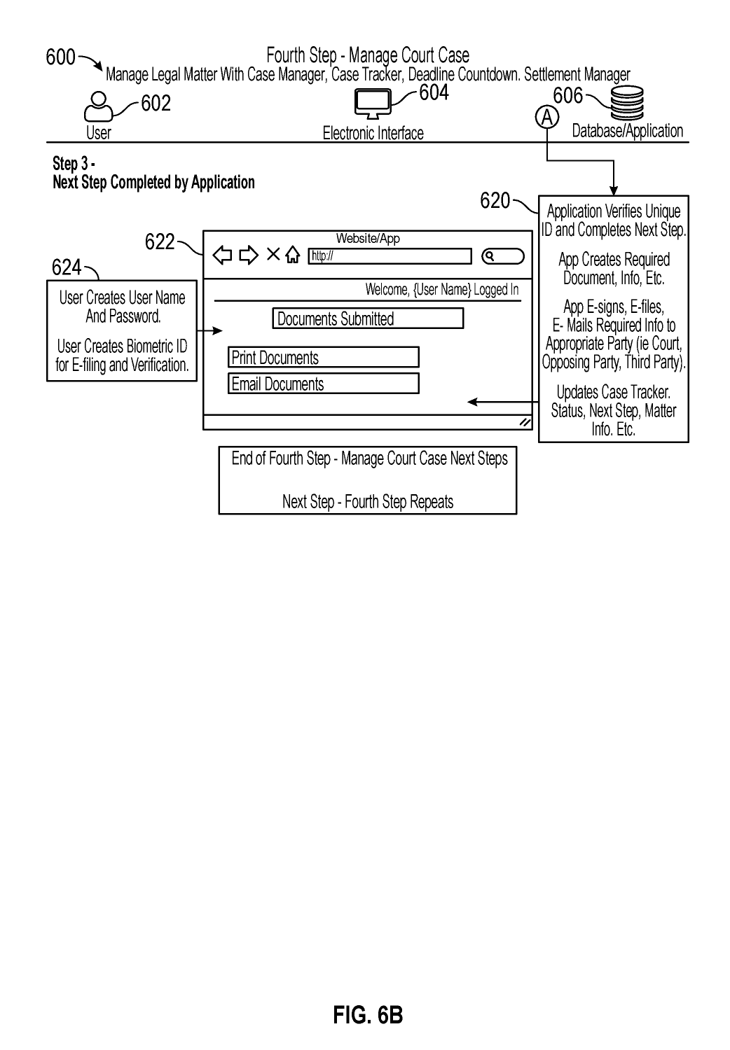

FIG. 6 is a schematic block and flow diagram 600 illustrating automated case management involving a user 602, an electronic interface 604 associated with an on line portal, and one or more databases 606. In particular, the flow diagram 600 depicts the system monitoring the court database to detect as change in status, an notifying the user of activity such as a filing, ruling, minute entry, upcoming event, and the like. Based on the status of the case, the system creates a next step action item and notifies the user accordingly (items 608, 610, 612).

The system may be configured to determine what information is needed to complete the next step, and to prompt the user to provide such information (items 614, 616). The user may then supply the requested information, and verify its accuracy, as appropriate (item 618). The system may then verify the user's identity (e.g., using a biometric scheme), populate the forms associated with the next step, file and/or serve the appropriate forms, and update the case tracker (items 620, 622, and 624).

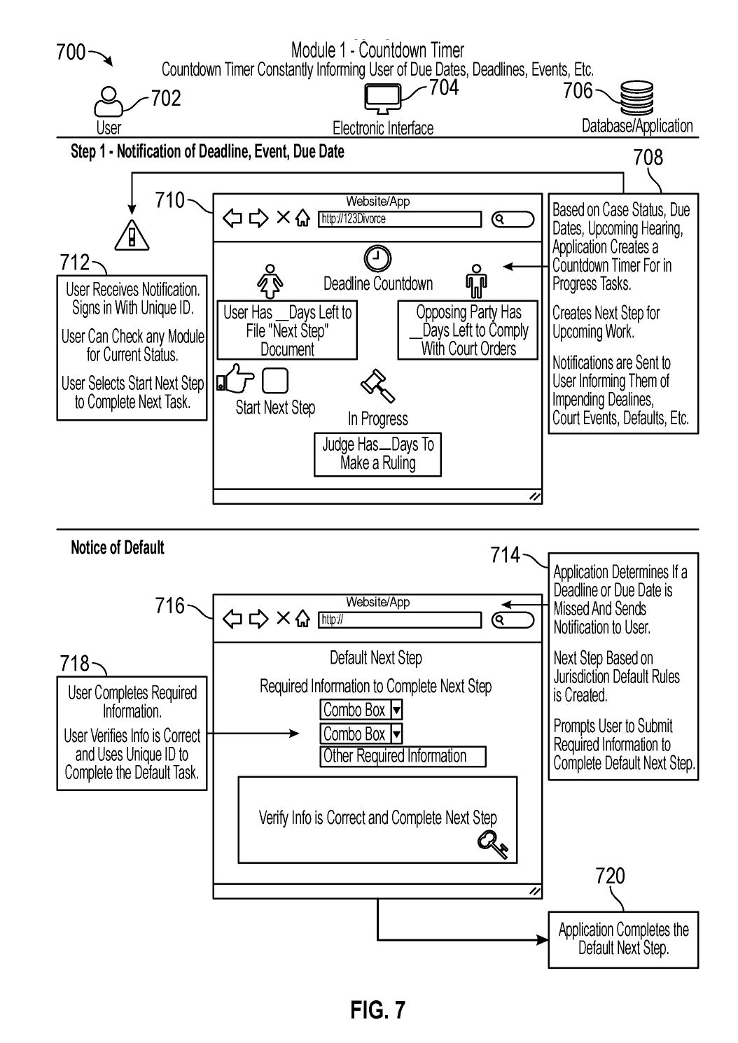

FIG. 7 is a schematic block and flow diagram 700 illustrating a countdown timer module involving a user 702, an electronic interface 704 associated with an on line portal, and one or more databases 706. In particular, the flow diagram 700 depicts the system creating a countdown timer for use in monitoring tasks based on the case status, upcoming due dates for performing tasks and filing documents, and upcoming hearings (item 708). The system displays this information to the user, and elicits any information from the user which may be needed to populate any required forms (items 710, 712).

With continued reference to FIG. 7, the system determines if a deadline or due date is missed by either the user or the opposing party, and prompts the user to either correct the missed deadline or move for default against the opposing party (item 714). The user may then provide the information needed to correct the missed deadline or prepare the default documents (items 716, 718). The system may then file the documents associated with the default action or other next step (item 720).

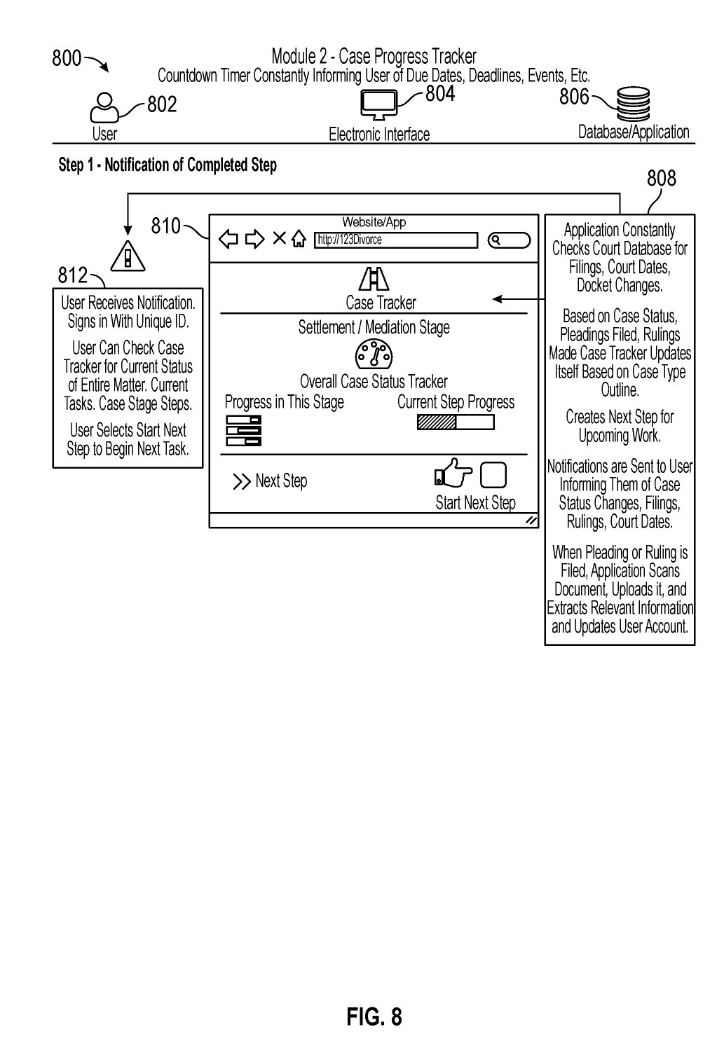

FIG. 8 is a schematic block and flow diagram 800 illustrating a case progress tracker module involving a user 802, an electronic interface 804 associated with an on line portal, and one or more databases 806. In particular, the flow diagram 800 depicts the system monitoring the court database on an ongoing basis to check for new filings, court dates, rulings, and docket changes. In particular, when a document or notice is added to the case docket, the system uploads it to the user account, extracts relevant information and updates the user account, and sends a notification to the user informing the user of the changes (item 808). In this way, the user is apprised of new developments without having to view the court documents (item 810).

With continued reference to FIG. 8, the user can sign into the system portal and view the case tracker using the user's unique ID, and select the “start next step” option to begin the next task (item 812).

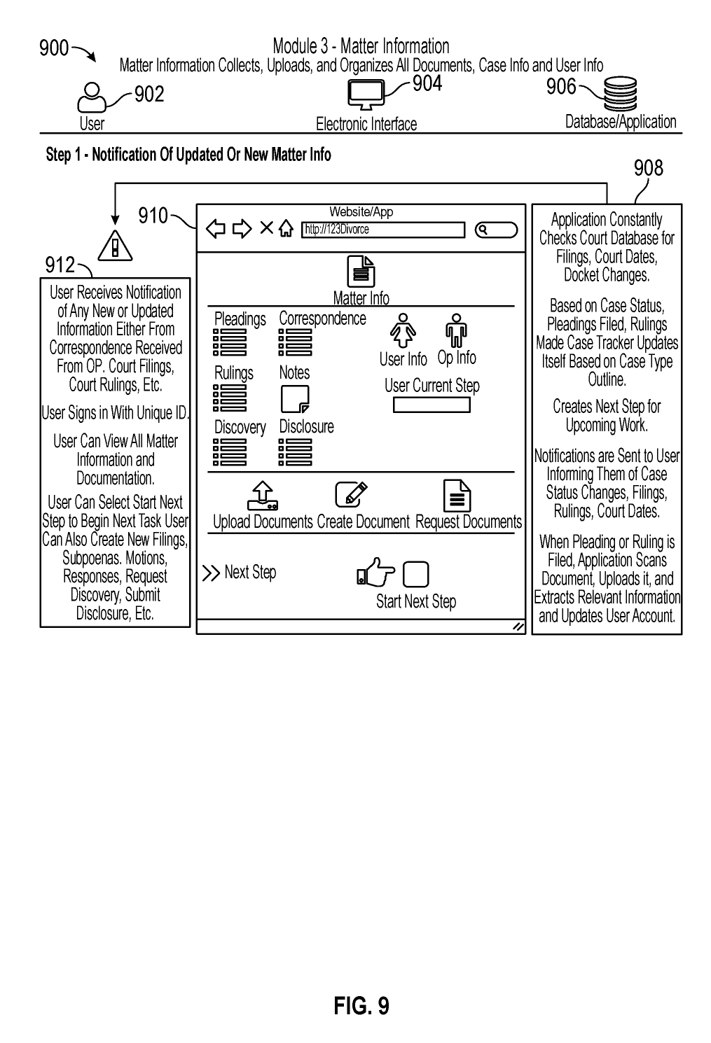

FIG. 9 is a schematic block and flow diagram 900 illustrating a module for organizing documents and case information involving a user 902, an electronic interface 904 associated with an on line portal, and one or more databases 906. In particular, the flow diagram 900 depicts the system creating next step tasks based on the court docket (item 908), and provides a dashboard display to the user which may include any combination of at least the following interactive icons: matter information; pleadings; correspondence; notes; rulings; discovery; disclosure; local rules; user information; subpoenas; opposing party information; status of service; current and next steps; upload documents; create documents; request documents; and start next step (items 910, 912).

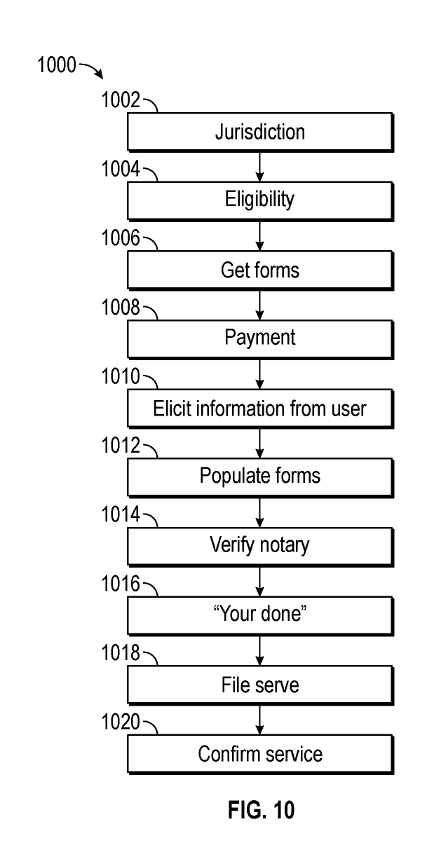

FIG. 10 is a flow chart illustrating a process 100 implemented by an on-line portal for facilitating the preparation, filing, and service of a divorce case in a manner which avoids the user having to view documents filed with the court and served on the opposing party. More particularly, the process 100 includes determining the appropriate jurisdiction in which to file the action (item 1002), determining whether the user is eligible to file the action (item 1004), and determining the specific forms needed to complete the action in the selected jurisdiction (item 1006). The system then coordinates payment with the user (item 1008).

The system then interactively elicits from the user the information associated with the various fields in the form set (item 1010), and automatically populates the forms for the user (item 1012). An optional on line notarization and/or verification module may be invoked, as needed (item 1014). Once the forms are populated and verified, the system advises the user the all steps necessary to file the divorce action have been performed (e.g., “Relax; your divorce is now filed”) (item 1016). The system files the documents in court and commences service on the opposing party (item 1018). Once service is completed, the system notifies the user that the injunction regarding marital assets is now effective (item 1020).

A method is thus provided for filing a divorce using an on line portal having an associated database. The method includes: interrogating the database to identify required forms; eliciting predetermined information from the user; populating the forms using the elicited information; and filing the populated forms in court; wherein the forms are not displayed to the user.

In an embodiment, the database includes substantive and procedural requirements for a plurality of jurisdictions.

In an embodiment, interrogating the database comprises selecting a particular one of the plurality of jurisdictions.

In an embodiment, the method further includes determining whether the selected jurisdiction permits electronic filing and, if so, electronically filing the populated forms in a court associated with the selected jurisdiction.

In an embodiment, the method further includes determining whether the selected jurisdiction permits electronic verification and, if so, facilitating electronic verification of the populated forms by the user.

In an embodiment, electronic verification includes electronic notarization.

In an embodiment, the method further includes verifying the user's identity using biometric indicia.

In an embodiment, verifying the user's identity includes invoking a third party module to perform one of e-signature and e-notarization.

In an embodiment, the biometric indicia includes at least one of facial recognition, retinal scan, finger print, palm print, video profile, and voice recognition.

In an embodiment, the method further includes determining whether the selected jurisdiction permits electronic service to an opposing party and, if so, facilitating electronic service of the populated forms to the opposing party.

In an embodiment, the method further includes presenting the user with at least one of the following options for serving the filed forms to an opposing party: certified mail; personal service using a human process server; service by publication; and electronic service.

In an embodiment, the required forms include a consent decree.

In an embodiment, the method further includes: serving the filed forms on an opposing party; and inviting the opposing party to use the on line portal to accept service and verify the consent decree.

In an embodiment, the method further includes: receiving, by the on line portal, acceptance of service and a verified consent decree from the opposing party; holding, by the on line portal, the consent decree verified by both the user and the opposing party for a predetermined period of time; and following the predetermined period of time, filing the consent decree verified by both the user and the opposing party with the court.

In an embodiment, the method further includes sending an electronic notification to the user immediately upon filing the consent decree, informing the user that the divorce is final.

In an embodiment, the predetermined period of time comprises sixty days.

In an embodiment, the method further includes updating the substantive and procedural requirements for the plurality of jurisdictions using an RSS feed.

A system is also provided for presenting a user with a payment request for filing an on line divorce in a court. The system includes: a cost module configured to outputs a payment request for display at a user computing device, wherein the payment request is responsive to at least the following inputs from the user: jurisdiction; user eligibility; and desired task; a database which includes one or more of: the forms needed to complete the desired task; the court costs and fees for receiving the desired task; a service fee for completing the desired task; and third party costs associated with verifying the user's identity and serving the filed documents upon an opposing party; and a processor configured to compute an amount of the payment request based on the inputs, and to present the payment request to the user only upon the user first providing information corresponding to the inputs.

A system is also provided for facilitating the preparation and filing of a divorce proceeding on line. The system includes: a database including substantive and procedural requirements for filing a divorce case in a plurality of jurisdictions; and a server hosting a web based application, the server configured to execute computer instructions stored in a non-transitory medium for performing the steps of: selecting a particular jurisdiction from the plurality of jurisdictions; interrogating the database to identify a required form having information fields, the form corresponding to the selected jurisdiction; prompting the user to provide information; populating the information fields with the information; electronically verifying the user's identity; prompting the user to verify the information; filing the populated form in court; and commencing electronic service of the filed form upon an opposing party.

In an embodiment, the recited steps are performed without showing the form to the user.

In an embodiment, prompting the user to verify the information includes eliciting biometric data from the user.

As used herein, the word “exemplary” means “serving as an example, instance, or illustration.” Any implementation described herein as “exemplary” is not necessarily to be construed as preferred or advantageous over other implementations, nor is it intended to be construed as a model that must be literally duplicated.

While the foregoing detailed description will provide those skilled in the art with a convenient road map for implementing various embodiments of the invention, it should be appreciated that the particular embodiments described above are only examples, and are not intended to limit the scope, applicability, or configuration of the invention in any way. To the contrary, various changes may be made in the function and arrangement of elements described without departing from the scope of the invention.

1. A method of filing for divorce using an on line portal having an associated database, comprising:
interrogating the database to identify required forms;
eliciting predetermined information from the user;
populating the forms using the elicited information; and
filing the populated forms in court;
wherein the forms are not displayed to the user.

2. The method of claim 1, wherein the database comprises substantive and procedural requirements for a plurality of jurisdictions.

3. The method of claim 2, wherein interrogating the database comprises selecting a particular one of the plurality of jurisdictions.

4. The method of claim 3, further comprising determining whether the selected jurisdiction permits electronic filing and, if so, electronically filing the populated forms in a court associated with the selected jurisdiction.

5. The method of claim 3, further comprising determining whether the selected jurisdiction permits electronic verification and, if so, facilitating electronic verification of the populated forms by the user.

6. The method of claim 5, wherein electronic verification comprises electronic notarization.

7. The method of claim 1, further comprising verifying the user's identity using biometric indicia.

8. The method of claim 7, wherein verifying the user's identity comprises invoking a third party module to perform one of e-signature and e-notarization.

9. The method of claim 7, wherein the biometric indicia comprises at least one of facial recognition, retinal scan, finger print, palm print, video profile, and voice recognition.

10. The method of claim 3, further comprising determining whether the selected jurisdiction permits electronic service to an opposing party and, if so, facilitating electronic service of the populated forms to the opposing party.

11. The method of claim 1, further comprising presenting the user with at least one of the following options for serving the filed forms to an opposing party: certified mail; personal service using a human process server; service by publication; and electronic service.

12. The method of claim 1, wherein the required forms include a consent decree.

13. The method of claim 12, further comprising:
serving the filed forms on an opposing party; and
inviting the opposing party to use the on line portal to accept service and verify the consent decree.

14. The method of claim 13, further comprising:
receiving, by the on line portal, acceptance of service and a verified consent decree from the opposing party;
holding, by the on line portal, the consent decree verified by both the user and the opposing party for a predetermined period of time; and
following the predetermined period of time, filing the consent decree verified by both the user and the opposing party with the court.

15. The method of claim 14, further comprising:
sending an electronic notification to the user immediately upon filing the consent decree, informing the user that the divorce is final.

16. The method of claim 2, further comprising:
updating the substantive and procedural requirements for the plurality of jurisdictions using an RSS feed.

17. A system for presenting a user with a payment request for filing an on line divorce in a court, comprising:
a cost module configured to outputs a payment request for display at a user computing device, wherein the payment request is responsive to at least the following inputs from the user: jurisdiction; user eligibility; and desired task;
a database which includes one or more of: the forms needed to complete the desired task; the court costs and fees for receiving the desired task; a service fee for completing the desired task; and third party costs associated with verifying the user's identity and serving the filed documents upon an opposing party; and
a processor configured to compute an amount of the payment request based on the inputs, and to present the payment request to the user only upon the user first providing information corresponding to the inputs.

18. A system for facilitating the preparation and filing of a divorce proceeding on line, comprising:
a database including substantive and procedural requirements for filing a divorce case in a plurality of jurisdictions; and
a server hosting a web based application, the server configured to execute computer instructions stored in a non-transitory medium for performing the steps of:
selecting a particular jurisdiction from the plurality of jurisdictions;
interrogating the database to identify a required form having information fields, the form corresponding to the selected jurisdiction;
prompting the user to provide information;
populating the information fields with the information;
electronically verifying the user's identity;
prompting the user to verify the information;
filing the populated form in court;
and
commencing electronic service of the filed form upon an opposing party.

19. The system of claim 18, wherein the recited steps are performed without showing the form to the user.

20. The system of claim 18, wherein prompting the user to verify the information comprises:
eliciting biometric data from the user.
